(19) United States
(12) Patent Application Publication
(10) Pub. No.: US 2018/0190399 A1
(43) Pub. Date: Jul. 5, 2018

(54) SYSTEM FOR SETTING TOLERANCE LIMIT OF CORRELATION BY USING REPETITIVE CROSS-VALIDATION AND METHOD THEREOF

(71) Applicant: KEPCO NUCLEAR FUEL CO., LTD., Daejeon (KR)

(72) Inventors: Kang Hoon KIM, Daejeon (KR); Byeung Seok KIM, Daejeon (KR); Kee Yil NAHM, Daejeon (KR)

(73) Assignee: KEPCO NUCLEAR FUEL CO., LTD., Daejeon (KR)

(21) Appl. No.: 15/563,267

(22) PCT Filed: Apr. 26, 2016
(86) PCT No.: PCT/KR2016/004340

§ 371 Date: Sep. 29, 2017

(30) Foreign Application Priority Data
Apr. 6, 2016 (KR) 10-2016-0042413

(51) Int. Cl. G21C 17/10; G05B 13/02

(52) U.S. Cl. CPC G21C 17/10; G05B 13/0265

(57) ABSTRACT

A system and method are provided for setting a tolerance limit of a correlation by using repetitive cross-validation to prevent intentional or unintentional distortion of data characteristics by human intervention or otherwise, and to prevent risk caused thereby, and to quantify the influence of the distortion of the data characteristics in fitting the correlation and setting the tolerance limit. The system for setting the tolerance limit of the correlation by using repetitive cross-validation according to an embodiment of this presentation includes a variable extraction unit extracting a variable by partitioning a training set and a validation set and by fitting the correlation coefficients; a normality test unit performing a normality test for variable extraction results; and a DNBR limit unit performing a same population test, and determining an allowable DNBR limit for a DNBR value distribution, based upon normality.

### TECHNICAL FIELD

The present invention relates to a system for setting a tolerance limit of a correlation by using repetitive cross-validation and a method thereof. More particularly, the present invention relates to a system for setting the tolerance limit of the correlation by using repetitive cross-validation and a method thereof to prevent intentional or unintentional distortion of data characteristics by human intervention or otherwise, to prevent risk caused by distortion of data characteristics, and to quantify the influence of the distortion of the data characteristics in fitting the correlation and setting the tolerance limit.

### BACKGROUND ART

Hitherto, according to Korean unexamined patent publication No. 2011-0052340, as a method of evaluating trip setpoint of reactor core state, a trip setpoint is calculated by using information on neutron flux distribution calculated in advance with respect to each of more than 600 reactor core states, information on instruments for regional overpower protection and information on thermal-hydraulics. Upon completion of a trip setpoint calculation, by deriving an optimal correlation between information on a signal distribution of instruments for regional overpower protection and the trip setpoint, a method is provided to determine the trip setpoint corresponding to each reactor core state using only the signal distribution of instruments.

In the conventional art, in a way to avoid over-fitting risk, fitting a correlation is performed on the basis of data partitioning (training set vs validation set) of one round or limited number of cases, or the tolerance limit and application scope of the correlation is set individually through simple statistics analysis with respect to a separated dataset by finalizing the fitting related task at a level of managing separately independent testing dataset having same design or similar design characteristics.

Regarding the limited number of cases, fitting the correlation and setting the tolerance limit based on separated dataset have a problem, wherein intentional or unintentional distortion of data characteristics by human intervention or otherwise is unable to be prevented, to prevent risk caused by unintentional distortion of data characteristics is unable to be prevented, and the influence of the distortion of the data characteristics in fitting the correlation and setting the tolerance limit is unable to be quantified.

In addition, in the case of managing separately independent testing dataset having the same design or similar design characteristics, as an influence due to the difference of detailed design characteristics along with reproducibility scope of test data is potentially involved, there may be limitations in separating the over-fitting risk or the influence. Consequently, it inevitably increases cost for additional production of testing data.

### DISCLOSURE

### Technical Problem

An object of the present invention, proposed in view of the aforementioned problems in the related art, is to perform fitting of a correlation and setting a tolerance limit within the scope of technical/regulatory requirements or to provide a system for setting the tolerance limit of the correlation by using repetitive cross-validation and a method thereof, which validates the effectiveness thereof.

Another object of the present invention is to provide the system for setting the tolerance limit of the correlation by using repetitive cross-validation and the method thereof, whereby intentional or unintentional distortion of data characteristics by human intervention or otherwise can be prevented, risk caused by distortion of data characteristics can be prevented, and the influence of the distortion of the data characteristics can be quantified.

### Technical Solution

A System for setting a tolerance limit of a correlation by using repetitive cross-validation according to an aspect of the present invention includes: a variable extraction unit 100 extracting a variable by partitioning a training set and a validation set and by fitting correlation coefficients; a normality test unit 200 performing a normality test for variable extraction results; a departure from nucleate boiling ratio (DNBR) limit unit 300 determining an allowable DNBR limit based upon normality; and a control unit 400 controlling the variable extraction unit, the normality test unit and the DNBR limit unit.

The variable extraction unit 100 may include an initialization module 110 partitioning the training set and the validation set, and extracting a run ID (Identification number) such as an initial DB (DataBase) from a full DB; a correlation fitting module 120 performing fitting of the correlation coefficients of a training initial set; an extraction module 130 extracting a maximum measurement/prediction (M/P) value for an individual run ID applying a fitting result of the correlation coefficients to the training set; a location and statistics change determination module 140 determining whether the location of an extracted maximum M/P value or the statistics of an average M/P value change or not; and a variable extraction module 150 extracting a relevant variable to the maximum M/P value, by applying a fitting result of the correlation coefficients to the validation set.

The normality test unit 200, when the training set and the validation set have a same population, determines whether M/P values have normality or not, the M/P values being extracted by a parametric method or a nonparametric method according to the normality test for a poolable dataset of the training set and the validation set.

In addition, the normality test unit 200, when the training set and the validation set do not have the same population, determines whether the M/P values have normality or not, the M/P values being extracted by the parametric method or the nonparametric method depending on the result of a normal distribution test performed in advance on the basis of the validation set only.

The DNBR limit unit 300 includes an output module 310 performing a same population test by using the parametric method and the nonparametric method for individual cases and outputting a 95/95 DNBR value distribution for the individual cases based upon normality of a poolable set M/P value and normality of a validation set M/P value; and a limit determination module 320 calculating the 95/95 DNBR value by using the parametric method or the 95/95 DNBR value by using the nonparametric method for the individual cases based upon normality of the output module, and determining a 95/95 DNBR limit by using the parametric method or the 95/95 DNBR limit by using the nonparametric method for the 95/95 DNBR value distribution for N cases.

A method of setting a tolerance limit of a correlation by using repetitive cross-validation, the method being performed by a control unit of the system of claim 1 includes: a step (a) of extracting, by the control unit, a variable by partitioning a training set and a validation set and by fitting correlation coefficients; a step (b) of performing, by the control unit, a normality test for variable extraction results; and a step (c) of determining, by the control unit, an allowable DNBR limit based upon tested normality.

The method, wherein the step (a) includes: a substep (a-1) of initializing, by the control unit, by partitioning the training set and the validation set and by extracting a run ID such as an initial DB from a full DB; a substep (a-2) of fitting, by the control unit, correlation coefficients by performing fitting of correlation coefficients of a training initial set; a substep (a-3) of extracting, by the control unit, a maximum M/P value by applying a fitting result of the correlation coefficients to the training set; a substep (a-4) of determining, by the control unit, whether a location of an extracted maximum M/P value and statistics of an average M/P value change or not; and a substep (a-5) of extracting, by the control unit, the variable by extracting a relevant variable to the maximum M/P value by applying a fitting result of the correlation coefficients to the validation set.

The method, wherein when the training set and the validation set have a same population in the step (b), the control unit determines whether M/P values have normality or not, the M/P values being extracted by a parametric method or a nonparametric method according to the normality test for a poolable dataset of the training set and the validation set.

In addition, The method, wherein, when the training set and the validation set do not have a same population in the (b), the control unit determine whether M/P values have normality or not, the M/P values being extracted by a parametric method or a nonparametric method depending on the result of a normal distribution test performed in advance on the basis of the validation set only.

The method, wherein the step (c) includes: a substep (c-1) of performing, by the control unit, a same population test by using a parametric method and a nonparametric method for individual cases and outputting a 95/95 DNBR value distribution for the individual cases based upon normality of a poolable set M/P value and normality of a validation set M/P value; and a substep (c-2) of calculating, by the control unit, the 95/95 DNBR value by using the parametric method or the 95/95 DNBR value by using the nonparametric method for the individual cases based upon normality of the poolable set M/P value and normality of the validation set M/P value, and determining a 95/95 DNBR limit by using the parametric method or the 95/95 DNBR limit by using the nonparametric method for the 95/95 DNBR value distribution for N cases.

### Advantageous Effects

As described above, in fitting a correlation and setting a tolerance limit, there is an effect of preventing intentional or unintentional distortion of data characteristics by human intervention or otherwise, preventing risk caused by distortion of data characteristics, and enabling quantifying of the influence of the distortion of the data characteristics.

### DESCRIPTION OF DRAWINGS

FIG. 1 is a block diagram illustrating a system for setting a tolerance limit of a correlation by using repetitive cross-validation according to an embodiment of the present invention.

FIG. 2 is a diagram illustrating the operation of a variable extraction unit of the system for setting the tolerance limit of the correlation by using repetitive cross-validation according to an embodiment of the present invention.

FIG. 3 is a diagram illustrating the operation of a normality test unit and a DNBR limit unit in the system for setting the tolerance limit of the correlation by using repetitive cross-validation according to an embodiment of the present invention.

FIG. 4 is an overall flow chart illustrating a method of using the system for setting the tolerance limit of the correlation by using repetitive cross-validation according to an embodiment of the present invention.

FIG. 5 is a graph illustrating the conceptual result of the system for setting the tolerance limit of the correlation by using repetitive cross-validation according to an embodiment of the present invention.

FIG. 6 is a graph illustrating the probability density function of a correlation M/P value and a concept of the tolerance limit of the system for setting the tolerance limit of the correlation by using repetitive cross-validation according to an embodiment of the present invention.

FIG. 7 is a graph illustrating the distribution of averages of a variable extracted through the variable extraction unit of the system for setting the tolerance limit of the correlation by using repetitive cross-validation according to an embodiment of the present invention.

### BEST MODE

Specific characteristics and advantageous features of the present invention will become clearer through description below with reference to the accompanying drawings. Prior to this, it should be noted that detailed descriptions of known functions and components incorporated herein have been omitted when they may make the subject matter of the present invention unclear.

Hereinafter, the present invention will be described in detail with reference to the accompanying drawings.

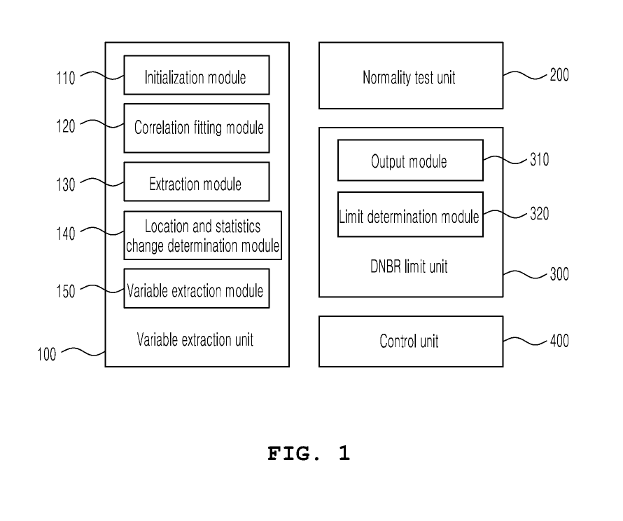

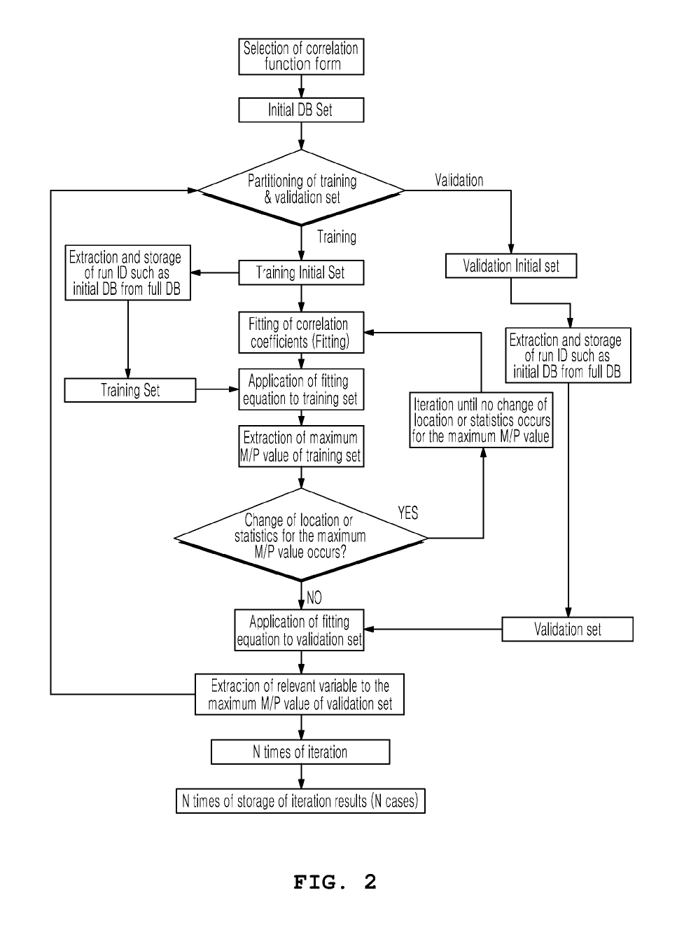

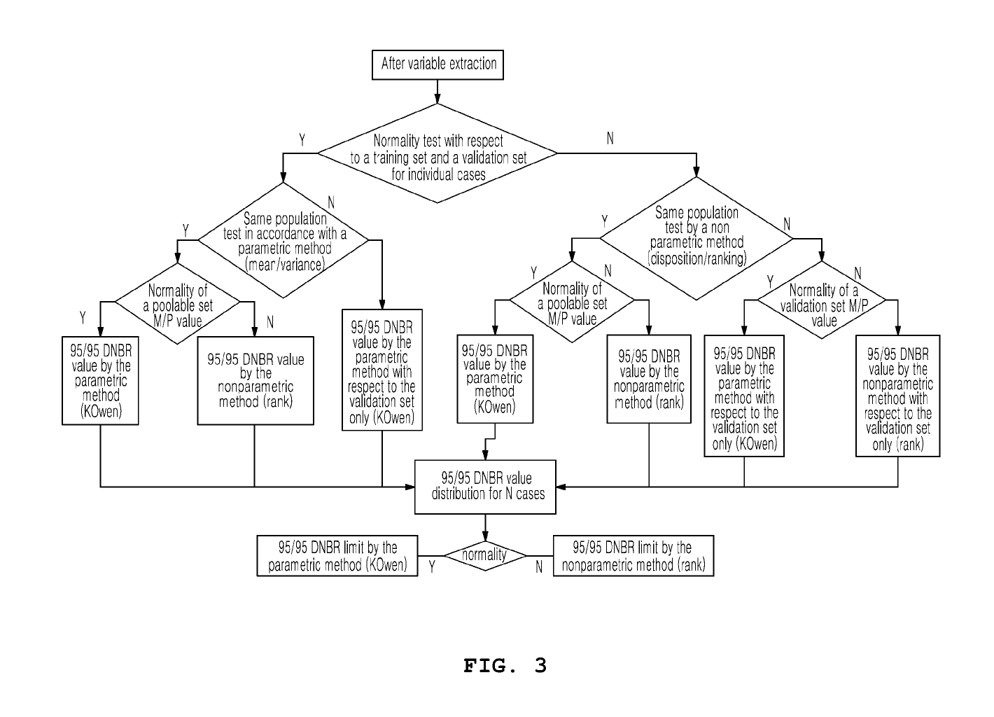

FIG. 1 is a block diagram illustrating a system for setting a tolerance limit of a correlation by using repetitive cross-validation according to an embodiment of the present invention, FIG. 2 is a diagram illustrating the operation of a variable extraction unit of the system for setting the tolerance limit of the correlation by using repetitive cross-validation according to an embodiment of the present invention, and FIG. 3 is a diagram illustrating the operation of a normality test unit and a DNBR limit unit in the system for setting the tolerance limit of the correlation by using repetitive cross-validation according to an embodiment of the present invention.

As illustrated in FIG. 1, the system for setting the tolerance limit of the correlation by using repetitive cross-validation according to an embodiment of the present invention includes a variable extraction unit 100, a normality test unit 200, a DNBR limit unit 300 and a control unit 400.

First of all, the variable extraction unit 100 performs the function N times by iterating a process, the process of extracting a variable by partitioning a training set and a validation set and by fitting the correlation coefficients.

The variable extraction unit 100 to perform this function includes an initialization module 110, a correlation fitting module 120, an extraction module 130, a location and statistics change determination module 140 and a variable extraction module 150.

An initialization module 110 partitions the training set and the validation set, the validation set extracts a run ID such as an initial DB from a full DB at a validation initial set and the training set extracts the run ID such as the initial DB from the full DB at a training initial set.

A correlation fitting module 120 performs fitting of correlation coefficients of the training initial set.

An extraction module 130 extracts a maximum M/P value for an individual run ID by applying a fitting result of the correlation coefficients to the training set. Here, the correlation according to an embodiment of the present invention is a critical heat flux (CHF) correlation and extracts the maximum statistics (average M/P value) for individual run ID.

a location and statistics change determination module 140 determines whether the location of an extracted maximum M/P value or statistics of an average M/P value have changed or not. The determination module 140 iteratively performs fitting stage for the correlation coefficients at the training initial set until no location change occurs in case of location change, or no statistics change occurs in case of statistics change, for the extracted maximum M/P value.

A variable extraction module 150 is able to extract a relevant variable to the maximum M/P value, by applying a fitting result of the correlation coefficients to the validation set, and store results by iterating the operation of the process for N times from the initialization module up to the variable extraction module.

Here, ‘N’ may be set to 5, 10, 20, 100, 200, 1000, 5000 or greater and around 1000 in a typical embodiment is appropriate.

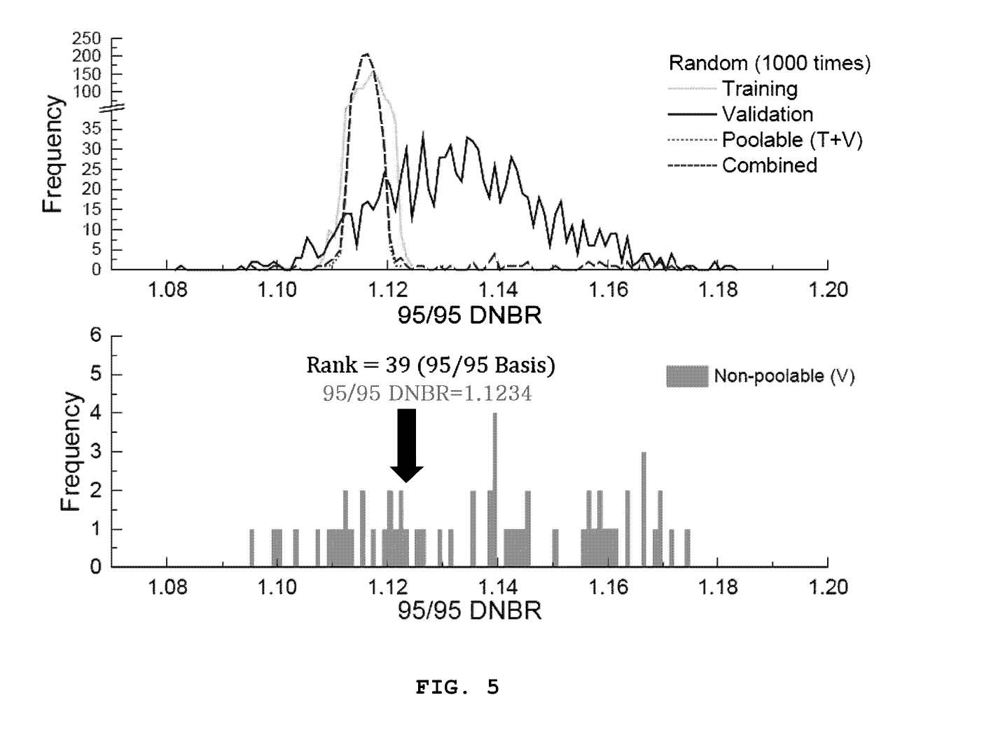

FIG. 5 is a graph illustrating the conceptual result of the system for setting the tolerance limit of the correlation by using repetitive cross-validation according to an embodiment of the present invention.

Conceptual results in a typical embodiment are shown in Table 1 and FIG. 5.

TABLE 1

| Individual | | | | | |
|---|---|---|---|---|---|
| tolerance | Dataset | No. of | | | |
| distribution | group | case | Average | S.D. | Remark |
| Poolability | Poolable | 941 | 1.1161 | 0.0017 | |
| | (T + V) | | | | |
| | Non-poolable | 59 | 1.1375 | 0.0220 | |
| | (V) | | | | |
| Combined | (T + V) and | 1000 | 1.1173 | 0.0075 | 1.1234 |
| | (V) | | | | (39th |
| | | | | | value*) |

*Table 1 above indicates nonparametric rank

The normality test unit 200 performs the normality test with respect to the result (maximum M/P value for individual run ID in the training set) of the extraction module passed through the location and statistics change determination module 140 and the result (maximum M/P value for individual run ID in the validation set) of the variable extraction module 150 or the poolable set, etc. Further, the unit 200 performs normality validation with respect to the 95/95 DNBR distribution produced in the DNBR limit unit.

The DNBR limit unit 300 performs the same population test by the parametric method and the nonparametric method for individual cases and outputs a 95/95 DNBR value for the individual cases based upon normality of a poolable set M/P value and normality of a validation set M/P value. Then the unit 300 outputs 95/95 DNBR value distribution for N cases, based on the 95/95 DNBR value and determines to choose 95/95 DNBR limit by the parametric method or 95/95 DNBR limit by the nonparametric method based upon normality of the 95/95 DNBR value distribution.

With this DNBR limit unit 300, determining the ultimate tolerance limit in compliance with 95/95 criteria (95% confidence level and 95% probability) by using the distribution, it is possible to prevent distortion of data characteristics, to prevent risk caused by the distortion of data characteristics, and to quantify the influence of the distortion of the data characteristics.

The DNBR limit unit 300 to perform this function includes an output module 310 and a limit determination module 320.

The output module 310 performs the same population test by using the parametric method and the nonparametric method for the individual cases and outputs a 95/95 DNBR value by the parametric method or a 95/95 DNBR value by the nonparametric method calculated by using the limit determination module 320 based upon normality of a poolable set M/P value and normality of a validation set M/P value. Then the module 310 outputs 95/95 DNBR value distribution for N cases, based on the 95/95 DNBR value. The module 320 calculates the 95/95 DNBR value by using the parametric method or the 95/95 DNBR value by the nonparametric method for the individual cases based upon normality of the output module 310 and determines a 95/95 DNBR limit by the parametric method or the 95/95 DNBR limit by the nonparametric method for the 95/95 DNBR value distribution for the N cases.

For reference, as a CHF correlation limit DNBR, the DNBR is the quantitative criteria assessing the occurrence of CHF on the nuclear fuel rod surface and is determined by assessing statistically the prediction uncertainty of the CHF correlation. According to the thermal design criteria for a reactor core, the CHF correlation limit DNBR should be so set that the probability that the CHF does not occur should be 95% or greater at the confidence level of 95% or greater. DNBR is defined as the ratio of predicted CHF (=P) and actual local heat flux (=A), namely DNBR=P/A. In experimental condition for the CHF, as actual local heat flux is identical to measured CHF (=M), DNBR has the same meaning as P/M. Though the CHF(P) predicted by the correlation in a constant local thermal-hydraulic condition is calculated always as a fixed value, CHF(M) actually measured in the same condition may have some arbitrary value due to the randomness of the physical phenomenon. In view of this, M/P value is selected as a random variable for statistical assessment of DNBR. To meet the design criteria on CHF, actual local heat flux in an arbitrary operating condition should be smaller than critical heat flux measured in the same condition. Namely A<M, here, provided the uncertainty of M is taken into consideration according to the 95/95 design criteria, the condition above is expressed as follow.

A<M(95/95 lower limit)

By applying DNBR=P/A, with both sides divided by P, it becomes,

DNBR>1/(M/P)_{95/95 lower limit}.

From this, a correlation limit DNBR(DNBR_{CL}) is defined as,

DNBR_{CL}≡(M/P)_{95/95 lower limit}.

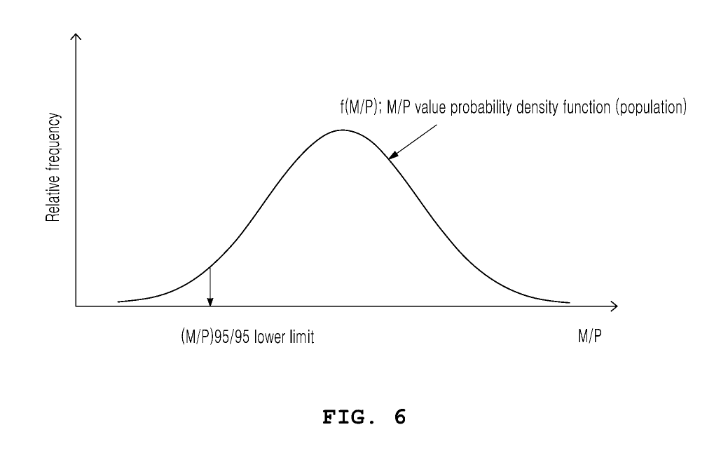

95/95 lower limit of M/P value is determined from the tolerance limit by estimating and assessing the population statistics from the M/P value sample as FIG. 6.

FIG. 6 is a graph illustrating the probability density function of a correlation M/P value and a concept of the tolerance limit of the system for setting the tolerance limit of the correlation by using repetitive cross-validation according to an embodiment of the present invention.

The control unit 400 is constituted to control the variable extraction unit 100, the normality test unit 200, and the DNBR limit unit 300.

In accordance with this control signal of the control unit, a method of using the system for setting the tolerance limit of the correlation by using repetitive cross-validation according to an embodiment of the present invention is described as follows.

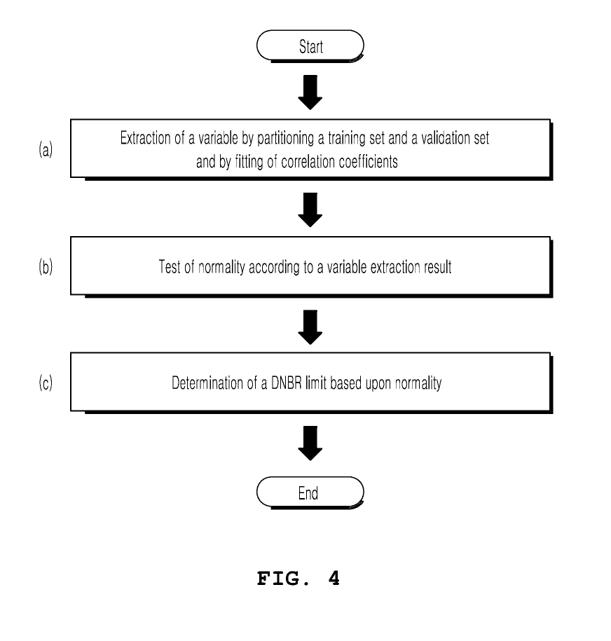

FIG. 4 is an overall flow chart illustrating the method of using the system for setting the tolerance limit of the correlation by using repetitive cross-validation according to an embodiment of the present invention.

As shown in the drawing, the method is performed as follows. (a) First, the control unit extracts the variable by partitioning the training set and the validation set and by fitting the correlation coefficients.

(b) Next, the control unit performs the normality test for the variable extraction results.

(c) Finally, the control unit determines the allowable DNBR limit based upon tested normality in the (b).

The process of fitting the correlation coefficients and extracting the variable in the step (a) is performed by: \textcircled{1} performing the data partitioning into the training set (T: training dataset) and validation set (V: validation dataset); \textcircled{2} in fitting the correlation (coefficients), performing fitting until no change of location or statistics occurs for the maximum M/P value for an individual run ID in T; \textcircled{3} calculating and extracting the maximum M/P value for the individual run ID in V; \textcircled{4} storing the M/P value for the individual run ID in T and V; and \textcircled{5} iterating the substeps \textcircled{1}˜\textcircled{4} (N cases) N times.

The variable extraction process in the step (a) is performed by the substeps of: (a-1) wherein partitioning the training set and validation set and extracting run ID such as initial DB from the full DB are performed, thereby realizing initialization; (a-2) wherein fitting of the correlation of training initial set is performed; (a-3) wherein extracting the maximum M/P value by applying correlation fitting results to the training set is performed; (a-4) wherein determining the change of location and statistics of the extracted maximum M/P value is performed, while it is allowed to iterate performing the fitting of the correlation until no change of location or statistics occurs; and (a-5) wherein, when no change of location or statistics occurs for the extracted maximum M/P value, extracting the variable to extract relevant variable to the maximum M/P, by applying the fitting result of the correlation coefficients to the validation set is performed.

The normality test for variable extraction results in the step (b) is performed as follows: \textcircled{6} the normality test for M/P value distribution in T and V for individual cases is performed; \textcircled{7} in performing the same population test for the individual cases, the parametric method is used when T and V are normal distributions and the nonparametric method is used when T or V is not normal distribution; \textcircled{8} in calculating 95/95 DNBR value for the individual cases, determination is made based on the poolable dataset group of T and V when T and V have the same population, wherein the parametric method or the nonparametric method is applicable depending on the results after performing the normality test for the poolable dataset group; and determination is made based on the V only when T and V do not have the same population, wherein the parametric method or the nonparametric method is applicable depending on the results of the normal distribution test performed in advance; \textcircled{9} based on the result of ‘\textcircled{8}’, 95/95 DNBR value distribution is produced with respect to T, V, poolable, non-poolable and combined (poolable+non-poolable); \textcircled{10} and the normality test is performed with respect to ‘\textcircled{9}’.

In addition, in the normality test in the step (b), the normality test is performed with respect to the training set and the validation set for the individual cases and normality of the M/P value extracted by the parametric method or the nonparametric method is determined.

Determination of an allowable DNBR limit in the step (c) is performed as follows: \textcircled{11} in calculating the 95/95 DNBR limit, the parametric method is used when the results in \textcircled{10} are normal distribution and the nonparametric method is used when the results in \textcircled{10} are not normal distribution; \textcircled{12} in determining the 95/95 DNBR limit, in an embodiment, the 95/95 tolerance of a ‘combined’ distribution is determined such as 1.1234→1.124 and the average of ‘validation’ is determined such as 1.1337→1.134 in the other embodiment.

The step (c) enables a substep (c-1) to output 95/95 DNBR value distribution for N cases based on the 95/95 DNBR value for the individual cases, based upon normality of poolable set M/P value and normality of validation set M/P value by the parametric method and the nonparametric method and a substep (c-2) to determine 95/95 DNBR limit by the parametric method or 95/95 DNBR limit by the nonparametric method, based upon normality.

In an embodiment of the present invention, data partitioning in setting of N should be random base, but data partitioning is allowed to include k-folds (perform data partitioning into k subgroups being not to overlap each other and iterate k times internally for k−1 subgroups as the training set and one subgroup as the validation set). Setting the tolerance limit and validation thereof is possible forvariables of implementation in an embodiment of the present invention using not only M/P value but also values of M/P−1, M−P or P/M, P/M−1, P−M, and P− and so on.

In the other embodiment, by expansion of the typical embodiment provided, implementation is possible in a form of performing iteration for N cases up to right before the ‘production of 95/95 DNBR value distribution for N cases.’ In addition, implementation is also possible to analyze ‘95/95 DNBR value distribution’ with respect to two dataset groups of training dataset and validation dataset for each or individual cases and the for the combination thereof when they have a same population or not.

TABLE 2

| Individual | | | | S.D. | |
|---|---|---|---|---|---|
| tolerance | | No. of | | (Standard | |
| distribution | Group | case | Average | Deviation) | Remark |
| All | Training | 1000 | 1.1168 | 0.0027 | |
| | Validation | 1000 | 1.1337 | 0.0151 | 1.134 |

An effect by an operation of the system for setting the tolerance limit of the correlation by using repetitive cross-validation according to the present invention reduces the tolerance limit by maximum 2.5% compared with existing one, and the reduction of the tolerance limit is possibly to be utilized for the increase of safety margin or enhancement of actual performance. Compared with domestic technology, the effect is the improvement by maximum 5%.

TABLE 3

| | | Presented | | Expected |
|---|---|---|---|---|
| | | tolerance | | tolerance |
| Case | | limit | Risk/Effect | limit |
| Existing/Similar technology | | 1.113 | Max. | 1.18 |
| not implemented (domestic level) | | | | |
| Existing/Similar technology | | 1.08~1.18 | Case-by- | 1.15 |
| implemented (overseas level) | | | case | |
| Invention | Typical | — | ~1% | 1.124 |
| technology | embodiment(95/95 | | | |
| | DNBR value | | | |
| | distribution | | | |
| | criteria with | | | |
| | respect to | | | |
| | combined data) | | | |
| | Other | — | ~2% | 1.134 |
| | embodiment(95/95 | | | |
| | DNBR value | | | |
| | distribution | | | |
| | criteria with | | | |
| | respect to | | | |
| | validation data) | | | |

* Compared with domestic technology level

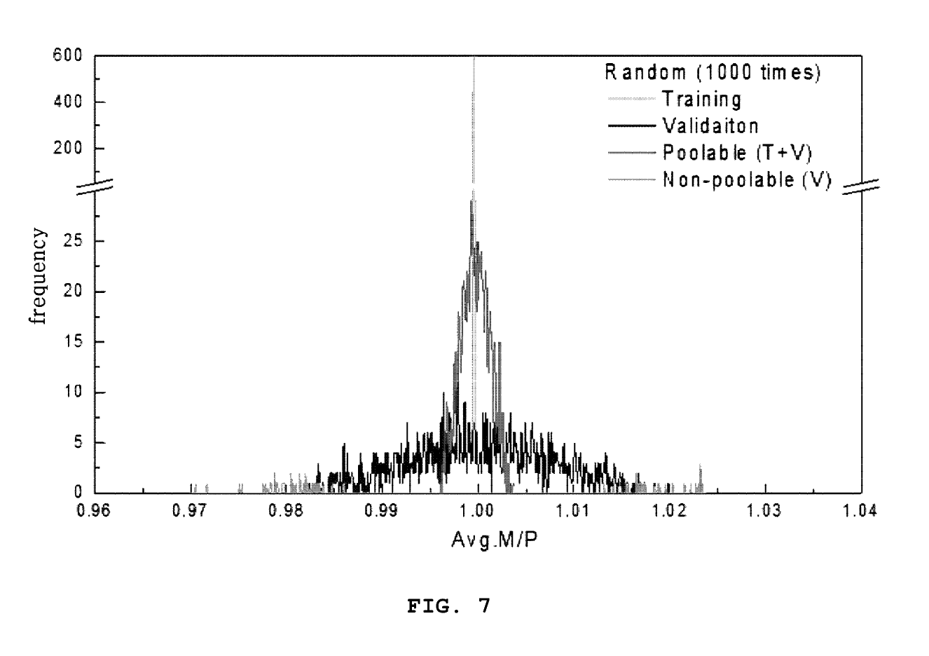

FIG. 7 is a graph illustrating the distribution of averages of a variable extracted through the variable extraction unit of the system for setting the tolerance limit of the correlation by using repetitive cross-validation according to an embodiment of the present invention.

This FIG. 7 shows, according to classification of FIG. 5, the average values of the variable (M/P value) extracted from two datasets (training and validation) for N cases produced from the results in FIG. 2 via the processes of FIG. 3 and FIG. 4.

The system for setting the tolerance limit of the correlation by using repetitive cross-validation according to an embodiment of the present invention has an ability to perform the same population test (parametric method or nonparametric method) among M/P values of training and validation dataset for N cases by referring to FIG. 3.

In addition, as a process of producing 95/95 DNBR value for the case of the same population or otherwise, the features are in the parametric method or the nonparametric method, and another feature is in the ability to determine 95/95 DNBR limit from the 95/95 DNBR values distribution

The system for setting the tolerance limit of the correlation by using repetitive cross-validation according to an embodiment of the present invention performs the following: OD the system partitions data into the training dataset (T) and the validation dataset (V);

\textcircled{2} in performing the fitting of the correlation (coefficients), the system performs the fitting until no change occurs for the location or statistics of the maximum M/P value for individual run ID in T;

\textcircled{3} the system calculates and extracts the maximum M/P value for individual run ID in V, and \textcircled{4} stores M/P value for individual run ID in T and V;

\textcircled{5} the system iterates the process of \textcircled{1}˜\textcircled{4} N times (N cases);

\textcircled{6} the system tests normality of the M/P value distribution for the individual cases in T and V;

\textcircled{7} the system, in testing the same population for the individual cases, performs the test by the parametric method when T and V are normal distributions and performs the test by the nonparametric method when T or V is not normal distribution;

\textcircled{8} in calculating 95/95 DNBR value for the individual cases, the system determines by using poolable dataset group of T and V as a reference when T and V have the same population. Here, the parametric method or the nonparametric method is applicable depending on the results after performing the normality test for the poolable dataset group;

the system determines by using V only as a reference when T and V do not have the same population, wherein the parametric method or the nonparametric method is applicable depending on the test results performed in advance for the normal distribution;

\textcircled{9} based on the result of ‘\textcircled{8}’, the system produces 95/95 DNBR value distribution with respect to T, V, poolable, non-poolable and combined (poolable+non-poolable);

\textcircled{10} the system tests normality for ‘\textcircled{9}’;

\textcircled{11} in calculating the 95/95 DNBR limit, the system calculates the limit by the parametric method when the results in \textcircled{10} are normal distribution and by the nonparametric method when the results in \textcircled{10} are not normal distribution; and

\textcircled{12} in determining the 95/95 DNBR limit, the system, in an embodiment, determines the 95/95 tolerance of a ‘combined’ distribution such as 1.1234→1.124 and, in the other embodiment, determines the average of ‘validation’ distribution such as 1.1337→1.134.

### DESCRIPTION OF THE REFERENCE NUMERALS IN THE DRAWINGS

1. A system for setting a tolerance limit of a correlation by using repetitive cross-validation, the system comprising:
a variable extraction unit (100) extracting a variable by partitioning a training set and a validation set and by fitting correlation coefficients;
a normality test unit (200) performing a normality test for variable extraction results; and
a DNBR limit unit (300) determining an allowable DNBR (departure from nucleate boiling ratio) limit based upon tested normality,
wherein the DNBR limit unit (300) comprises:
an output module (310) performing a same population test by using a parametric method and a nonparametric method for individual cases and outputting a 95/95 DNBR value distribution for the individual cases based upon normality of a poolable set M/P value and normality of a validation set M/P value; and
a limit determination module (320) calculating the 95/95 DNBR value by using the parametric method or the 95/95 DNBR value by using the nonparametric method for the individual cases based upon normality of the output module, and determining a 95/95 DNBR limit by using the parametric method or the 95/95 DNBR limit by using the nonparametric method for the 95/95 DNBR value distribution for N cases.

2. The system of claim 1, wherein the variable extraction unit (100) comprises:
an initialization module (110) partitioning the training set and the validation set and extracting a run ID such as an initial DB from a full DB;
a correlation fitting module (120) performing fitting of correlation coefficients of a training initial set;
an extraction module (130) extracting a maximum M/P (measurement/prediction) value for an individual run ID by applying a fitting result of the correlation coefficients to the training set;
a location and statistics change determination module (140) determining whether a location of an extracted maximum M/P value or statistics of an average M/P value change or not; and
a variable extraction module (150) extracting a relevant variable to the maximum M/P value, by applying a fitting result of the correlation coefficients to the validation set.

3. The system of claim 1, wherein, when the training set and the validation set have a same population, the normality test unit (200) determines whether M/P values have normality or not, the M/P values being extracted by a parametric method or a nonparametric method according to the normality test for a poolable dataset of the training set and the validation set.

4. The system of claim 1, wherein, when the training set and the validation set do not have a same population, the normality test unit (200) determines whether M/P values have normality or not, the M/P values being extracted by a parametric method or a nonparametric method depending on the result of a normal distribution test performed in advance on the basis of the validation set only.

5. (canceled)

6. A method of setting a tolerance limit of a correlation by using repetitive cross-validation, the method being performed by a control unit of the system of claim 1, and comprising:
(a) extracting, by the control unit, a variable by partitioning a training set and a validation set and by fitting correlation coefficients;
(b) performing, by the control unit, a normality test for variable extraction results; and
(c) determining, by the control unit, an allowable DNBR (departure from nucleate boiling ratio) limit based upon tested normality,
wherein the (c) comprises:
(c-1) performing, by the control unit, a same population test by using a parametric method and a nonparametric method for individual cases and outputting a 95/95 DNBR value distribution for the individual cases based upon normality of a poolable set M/P value and normality of a validation set M/P value; and
(c-2) calculating, by the control unit, the 95/95 DNBR value by using the parametric method or the 95/95 DNBR value by using the nonparametric method for the individual cases based upon normality of the poolable set M/P value and normality of the validation set M/P value, and determining a 95/95 DNBR limit by using the parametric method or the 95/95 DNBR limit by using the nonparametric method for the 95/95 DNBR value distribution for N cases.

7. The method of claim 6, wherein the (a) comprises:
(a-1) initializing, by the control unit, by partitioning the training set and the validation set and by extracting a run ID such as an initial DB from a full DB;
(a-2) fitting, by the control unit, correlation coefficients by performing fitting of correlation coefficients of a training initial set;
(a-3) extracting, by the control unit, a maximum M/P (measurement/prediction) value by applying a fitting result of the correlation coefficients to the training set;
(a-4) determining, by the control unit, whether a location of an extracted maximum M/P value and statistics of an average M/P value change or not; and
(a-5) extracting, by the control unit, the variable by extracting a relevant variable to the maximum M/P value by applying a fitting result of the correlation coefficients to the validation set.

8. The method of claim 6, wherein when the training set and the validation set have a same population in the (b), the control unit determines whether M/P values have normality or not, the M/P values being extracted by a parametric method or a nonparametric method according to the normality test for a poolable dataset of the training set and the validation set.

9. The method of claim 6, wherein, when the training set and the validation set do not have a same population in the (b), the control unit determines whether M/P values have normality or not, the M/P values being extracted by a parametric method or a nonparametric method depending on the result of a normal distribution test performed in advance on the basis of the validation set only.

10. (canceled)
